(19) United States
(12) Patent Application Publication
(10) Pub. No.: US 2003/0014174 A1
(43) Pub. Date: Jan. 16, 2003

(54) Circuit arrangement and device for regulation and control of the speed of a motor vehicle

(76) Inventor: Bernhard Giers, Frankfurt/M (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/203,681

(22) PCT Filed: Feb. 3, 2001
(86) PCT No.: PCT/EP01/01168

(30) Foreign Application Priority Data
Feb. 9, 2000 (DE) 100 05 744.6
Dec. 22, 2000 (DE) 100 64 753.7

(51) Int. Cl. G06G 7/76

(52) U.S. Cl. 701/70; 701/79

(57) ABSTRACT

The present invention relates to a circuit arrangement and a device for regulation and control of the driving speed of a motor vechicle, including a functional group for regulating the driving speed according to a nominal value predetermined by the driver and a functional group for limiting the driving speed by a control and/or regulation intervention with respect to a limit value that depemds on the driving situation, predetermined criteria and the actual speed. The circuit arrangement (4) for regulation and control of the driving speed is designed as a component of an overall system (1 to 4) which comprises a wheel slip control system (1 to 3) such as an ABS, a TCS, an ESP, etc., and evaluates control quantities of the wheel slip control system (1 to 3) to limit the driving speed in predefined situations.

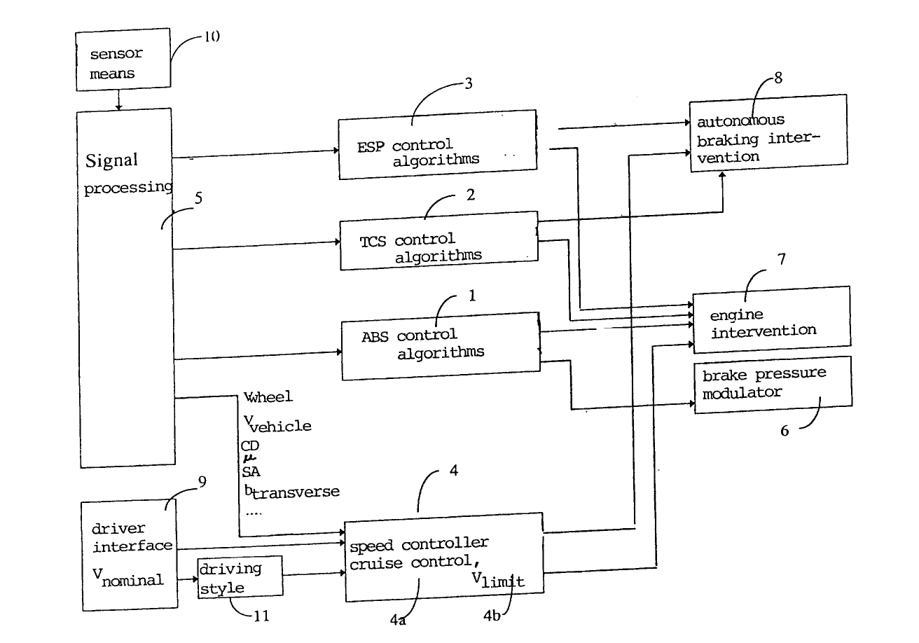

### TECHNICAL FIELD

The present invention generally relates to vehicle speed control and more particularly relates to a circuit arrangement and a device for regulation and control of the driving speed of a motor vehicle.

### BACKGROUND OF THE INVENTION

DE 44 34 022 C2 discloses a method and a device for limiting the driving speed of a motor vehicle to a predetermined limit speed, comprising a cruise control that determines the driving speed when the speed requested by the driver is in the range of speeds to be maintained. When the speed requested by the driver is in a range of speeds to be avoided, a speed-controlling system intervention will be effected according to a predetermined control characteristic curve as a function of the actual speed.

DE 195 09 494 C2 discloses a device for regulating the driving speed of a motor vehicle which, alternatively, initiates a cruise control or a limitation of the speed to an adjustable limit speed.

### BRIEF SUMMARY OF THE INVENTION

While the speed controllers known in the art are generally restricted to adjusting the nominal speed predetermined by the driver and preventing that this speed or a maximum speed is exceeded, an object of the present invention is to relieve the driver to a greater extent and to set a driving speed which comfortably takes account of different situations such as cornering maneuvers or straight travel, high or low coefficients of friction, normal roads or rough roadways, etc. It is desired to relieve the driver to a comparatively far-reaching degree by way of an automatic adaptation of the speed to varying situations.

It has been found that this object can be achieved by the circuit arrangement of the present invention, the special features of which include that the circuit arrangement for regulation and control of the driving speed is designed as a component of an overall system which comprises a wheel slip control system such as an anti-lock braking system (ABS), a traction control system (TCS), an electronic stability control (ESP) etc., and that input or control quantities of the wheel slip control system are evaluated to limit the driving speed in defined situations, in particular in situations that are critical in terms of driving safety or driving stability, or driving comfort.

In a particularly favorable embodiment of the present invention, the limit value of the driving speed, when cornering is detected, is reduced in dependence on the curve radius or the steering angle, or in the event of a transverse acceleration which is in excess of an acceleration limit value.

In another embodiment of the present invention, the limit value of the driving speed is varied in dependence on the current frictional value (coefficient of friction) or a measured variable representative of this value. The coefficient of friction is an important control variable for an ABS, TCS, or ESP, etc. comprised in the overall system, the said control variable being also used for regulation of the driving speed.

The integration of the driving speed control with a wheel slip control system such as ABS, TCS, ESP, etc., as provided by the present invention, permits evaluating important additional data, e.g. relating to straight travel or cornering, transverse acceleration, coefficient of friction, rough roadways, etc., for the regulation and control of the driving speed. This is achieved without a considerable increase in the manufacturing complexity because the additional data for the speed control is furnished by the wheel slip control systems.

Further details of the invention are explained with the reference to the attached drawing as follows

### BRIEF DESCRIPTION OF THE DRAWING

The attached drawing shows in a schematically simplified illustration the essential elements of a circuit arrangement according to the present invention and serves to depict the concept underlying the present invention.

An overall system is illustrated which, in the embodiment of this invention shown, is comprised of different functional groups 1, 2, 3, and 4 which all are connected to an input circuit 5 illustrated as a switching block and receive the data required for the regulation and control operations from the input circuit. ‘Sensor means’ refers to a block 10 which combines the different sensors and input stages (wheel sensors, steering angle sensor, transverse acceleration sensor, gearshift detection, cornering detection, etc.), and the input quantities and data necessary for wheel slip control are produced above all by block 10.

The input switching block 5 represents a signal-conditioning and signal-evaluating circuit in which the data originating from the different sources and obtained especially by means of the sensor means 10 is processed.

In functional group 1, in which the functions or program steps combined under the term ‘ABS control algorithms’ are comprised, brake intervention signals and brake control signals that prevent locking of the vehicle wheels in a known fashion are produced on the basis of wheel sensor signals. Therefore, a brake pressure modulator 6 is connected to the output of the functional group 1. Engine intervention 7 by the ABS module (1) is also provided, e.g. for regulating the engine drag torque in critical situations.

The steps, functions, and calculations for driving slip control or traction control of the vehicle are combined in the functional group 2, the output signals of which lead to the ‘engine intervention’ 7 and the ‘autonomous brake intervention’ 8.

The signal evaluation and signal processing and the control algorithms for regulating the driving stability of a vehicle (ESP control algorithms) are combined in the functional group 3 having outputs that lead to the ‘autonomous brake intervention’ 8 and the ‘engine intervention’ 7.

The output signals of the functional groups 1, 2, 3 are converted in a known fashion into brake pressure modulation signals (6) and engine intervention signals (7). The brake pressure modulator 6 is a basic component of an ABS, the engine intervention 7 is mainly required for driving slip control and traction control. The functional group 8 is referred to by ‘autonomous brake intervention’, because the output signals of the ‘ESP control algorithms’ 3 are converted in this group into brake-actuating signals for maintaining and restoring the driving stability by means of the brake system, however, without brake application by the driver.

An essential component of the overall circuit according to the present invention is the functional group 4 referred to as speed controller, which comprises a ‘cruise control’ 4a and a speed limiter ‘Vₗᵢₘᵢₜ’ 4b. According to the present invention, the speed controller 4 additionally takes care of the regulation and control of the driving speed of the motor vehicle in dependence on information supplied by the signal processing 5.

The speed controller 4 represents circuit parts or program parts for regulating the driving speed of the vehicle in dependence on a speed nominal value Vₙₒₘᵢₙₐₗ which the driver predefines by actuating the accelerator pedal and/or switches. This is expressed in the attached drawing by a ‘driver interface’ 9. Besides, the speed controller 4 comprises the circuit parts and program steps for limiting the driving speed of the vehicle by control and/or regulation intervention with respect to a limit value Vₗᵢₘᵢₜ that depends on the driving situation, predetermined criteria, and the actual speed of the vehicle. As input signals, the speed controller 4 receives data about the nominal speed Vₙₒₘᵢₙₐₗ predetermined by the driver. Besides, the data about the vehicle speed V_{vehicle}, the wheel speeds V_{wheel}, transverse acceleration bₜᵣₐₙₛᵥₑᵣₛₑ, cornering detection CD, steering angle SA, current coefficient of friction μ, etc., is sent to the speed controller 4. A rough road detection could also be provided. As is known, such data is anyway required for wheel slip control systems ABS (1), TCS (2), and ESP (3).

Hence, according to the present invention, the speed controller 4 is configured as a part of the overall system described and comprises both a speed controller 4a (cruise control) for adjusting a defined driving speed in dependence on the speed nominal value Vₙₒₘᵢₙₐₗ predetermined by the driver, and also steps or measures (4b) for limiting the driving speed and presetting a defined speed variation in dependence on the nominal speed predetermined by the driver and on the current driving situation, i.e., straight travel or cornering, on the instantaneous coefficient of friction or road condition—dry roadway or slippery roadway—, on the curve radius, and/or on the current transverse acceleration of the vehicle which depends on the actual speed and the curve radius. In general, it is deemed appropriate and felt to be comfortable that the driving speed is reduced in the curve, depending on the curve radius and driving style of the driver.

According to a particularly favorable embodiment of the present invention, the limit values of the driving speed or, respectively, the limit value variation are adapted to the preferred driving style, the way of driving or the driving characteristics of the driver in dependence on the driving situation, the curve radius, etc. This adaptation to the ‘driving style’ is represented in the attached drawing by a function circuit 11.

The adaptation to the driving style (11) can be effected by adjusting the regulation or control according to predetermined schemes. It is, however, also possible to implement a learning algorithm into the speed controller 4 in order to individually adapt the speed or the speed limit value variation to the driver. Many ways are possible to reach this aim. For example, an observation of the individual driving behavior permits sensing and evaluating the maximum transverse acceleration of the vehicle to which the driver usually reacts by reducing the vehicle speed, and a corresponding limit value or limit value variation may be predetermined. The relevant values are suitably averaged over a long period of time. This is only one of a number of embodiments.

The basic reflections which had the present invention as a result are summarized once more in the following.

Nowadays wheel slip control systems (1 to 3) generally have a bus serial interface to the engine management (7) which may take direct influence on e.g. the throttle valve position of the driving engine. The engine management (7) is e.g. used in a traction slip control (2) for reducing excessive driving torques, and in an anti-lock system (1) for reducing unwanted drag torque by the driving engine.

The serial interfaces provided in these wheel slip control systems (1, 2, 3) are used for driving engine control according to the present invention. The possibility of direct brake intervention (8) or brake pressure modulation (6) is made use of for the development of a brake torque without driver intervention (8) or for brake pressure modulation (6) during a brake operation (6).

The functions described hereinabove are suitably realized by software, e.g., by a corresponding programming of the brake intervention and engine management.

The function of the classical speed controller is vitally improved and extended by the concept of an overall circuit according to the present invention, that is by integration of wheel slip control systems with a speed controller. While nowadays speed controllers have to manage without brake intervention in the majority of cases, there is principally the possibility of brake intervention when the speed controller is integrated into the wheel slip control system. When driving downhill, the speed of the vehicle can be reduced by control to the desired nominal value with the aid of the engine drag torque and the brake torque.

The very precise algorithms provided in today's wheel slip control systems and intended to determine the wheel speed and vehicle speed permit a very accurate and effective nominal value regulation. In comparison with a conventional cruise control, the following advantages are achieved among others:

Omission of a control unit (speed controller); with the result of cost reduction.

Omission of sensors for speed measurement by using the ABS sensors.

Extension of functions by the standard possibility of development of brake torques.

Reducing the risk of wrong interventions by applying safety technology that is customary in wheel slip control systems.

The signal conditioning of the vehicle speed redundant in control units is omitted.

Further function improvements are achieved by using cornering detection, rough road detection, slip detection, etc. that are required anyway for wheel slip control systems.

The coordination of the wheel slip control with the speed control permits maintaining the predetermined nominal speed more accurately.

In addition, the coordination of the wheel slip control with the speed control allows an extension of functions to the effect that the predetermined vehicle nominal speed can be automatically limited permanently or for a certain time by the request of the slip control. This is rendered possible e.g. by information that can be obtained with ESP sensors, i.e., by information about the current coefficient of friction or about the driving maneuver, by cornering detection, rough road detection, detection of transverse acceleration or steering movements, etc.

Thus, the advantages achieved over systems known in the art are vital.

1. Circuit arrangement for regulation and control of the driving speed of a motor vehicle, including a functional group for regulating the driving speed according to a nominal value predetermined by the driver and a functional group for limiting the driving speed by a control and/or regulation intervention with respect to a limit value (Vₗᵢₘᵢₜ) that depends on the driving situation, predetermined criteria and the actual speed,
characterized in that the circuit arrangement for regulation and control of the driving speed (4) is designed as a component of an overall system (1 to 4) which comprises a wheel slip control system (1 to 3) such as an ABS (1), and/or a TCS (2), and/or an ESP (3), etc., and in that input or control quantities (V_{wheel}, V_{vehicle}, bₜᵣₐₙₛᵥₑᵣₛₑ, μ, CD, SA, etc.) of the wheel slip control system (1 to 3) are evaluated to regulate and limit the driving speed of the vehicle in predefined situations, in particular in situations critical in terms of driving safety, driving stability, or driving comfort.

2. Circuit arrangement as claimed in claim 1,
characterized in that the limit value of the driving speed, when cornering is detected (CD), is reduced in dependence on the curve radius or the steering angle (SA), and/or in the event of a transverse acceleration (bₜᵣₐₙₛᵥₑᵣₛₑ) or a corresponding measured quantity which is derived from the transverse acceleration.

3. Circuit arrangement as claimed in claim 1 or 2,
characterized in that the limit value of the driving speed (Vₗᵢₘᵢₜ) is varied in dependence on the current coefficient of friction μ or a measured variable representative of the coefficient of friction.

4. Circuit arrangement as claimed in any one or more of claims 1 to 3,
characterized in that the limit value of the driving speed during cornering is reduced in dependence on the current coefficient of friction or a measured variable representative of the coefficient of friction.

5. Circuit arrangement as claimed in any one or more of claims 1 to 4,
characterized in that the limit value of the driving speed (Vₗᵢₘᵢₜ) and/or the limit value variation during cornering, during transverse acceleration, at a low coefficient of friction, etc., is adapted to the ‘style of driving’ or the driving characteristics of the driver by predefining or presetting a control or speed characteristics or by gathering the driving behavior of the driver in a learning process.

6. Circuit arrangement as claimed in any one or more of claims 1 to 5,
characterized in that information with respect to cornering detection (CD) or determination of the transverse acceleration, for establishing the coefficient of friction, and/or other information for adapting the limit value or the limit value variation is obtained by means of the wheel slip control system (1, 2, 3) and sent to the functional group for limiting the driving speed of the speed controller (4).

7. Device for regulation and control of the driving speed of a motor vehicle, including a functional group for regulating the driving speed according to a nominal value predetermined by the driver and a functional group for limiting the driving speed by a control and/or regulation intervention with respect to a limit value (Vₗᵢₘᵢₜ) that depends on the driving situation, predetermined criteria and the actual speed,
characterized in that the device for regulation and control of the speed (4) is designed as a component of an overall system (1 to 4) which comprises a brake system with a wheel slip control system (1 to 3) such as an ABS, and/or a TCS, and/or an ESP, etc., and the speed regulation system (4).
